(19) United States
(12) Patent Application Publication
(10) Pub. No.: US 2015/0235754 A1
(43) Pub. Date: Aug. 20, 2015

(54) FERRITE INDUCTORS FOR LOW-HEIGHT AND ASSOCIATED METHODS

(71) Applicant: Volterra Semiconductor Corporation, San Jose, CA (US)

(72) Inventor: Alexandr Ikriannikov, Castro Valley, CA (US)

(73) Assignee: Volterra Semiconductor Corporation, San Jose, CA (US)

(21) Appl. No.: 14/293,044

(22) Filed: Jun. 2, 2014

Related U.S. Application Data
(60) Provisional application No. 61/940,686, filed on Feb. 17, 2014.

(51) Int. Cl. H01F 27/26; H01F 41/02

(52) U.S. Cl. CPC H01F 27/263; H01F 41/02

(57) ABSTRACT

A low-height coupled inductor having length, width, and height includes a composite magnetic core including: (1) first and second magnetic plates separated from each other in the height direction, and (2) a plurality of coupling teeth connecting the first and second magnetic plates in the height direction. The plurality of coupling teeth are formed of magnetic material having a lower magnetic permeability than magnetic material forming the first and second magnetic plates. The low-height coupled inductor further includes a respective winding wound around each of the plurality of coupling teeth.

### RELATED APPLICATIONS

This application claims benefit of priority to U.S. Provisional Patent Application No. 61/940,686, filed Feb. 17, 2014, which is incorporated herein by reference.

### BACKGROUND

Inductors are commonly used for filtering and for energy storage in power supplies, such as in DC-to-DC converters. For example, a buck DC-to-DC converter includes an inductor which, in cooperation with one or more capacitors, filters a switching waveform. Power supplies including multiple power stages often include at least one inductor per power stage. Some power supplies, however, use a coupled inductor in place of multiple discrete inductors, such as to improve power supply performance, reduce power supply size, and/or reduce power supply cost. Examples of coupled inductors and associated systems and methods are found in U.S. Pat. No. 6,362,986 to Schultz et al., which is incorporated herein by reference.

There is an increasing demand for low-height inductors, particularly inductors having a height of less than 0.75 millimeters. For example, the small form factors of many modern information technology devices, such as smart phones and tablet computers, require low-height inductors. As another example, inductor height is severely constrained in the emerging field of integrated voltage regulators.

Low-height discrete inductors have been formed using multilayer film technology, where a number of magnetic film layers and conductive electrodes are stacked to form an inductor. The magnetic film layers have a relatively low magnetic permeability, and therefore, the inductor must have a relatively large number of winding turns to obtain an inductance that is sufficiently large for typical applications. This large number of winding turns causes the inductor's winding to have a large direct current resistance (DCR) because DCR is proportional to winding length. Thus, it is typically infeasible to obtain both large inductance values and low winding DCR in conventional multilayer film inductors. As a result, multilayer film inductors usually have limited current ratings to prevent excessive losses and resulting temperature rise that would occur if the inductors were subjected to high current magnitudes.

Discrete inductors having a relatively low-height have also been formed from ferrite magnetic material. Ferrite magnetic material typically has a much larger magnetic permeability than magnetic film, and therefore, a ferrite inductor will ordinarily achieve a given inductance value with fewer winding turns than a multilayer film inductor. However, ferrite magnetic material is fragile and is difficult to handle in small pieces. Consequentially, conventional low-height ferrite inductors are restricted to simple magnetic cores, such as drum magnetic cores, to obtain acceptable manufacturing yields.

For example, FIG. 1 is a side plan view of prior-art inductor 100 including a drum magnetic core 102 formed of ferrite magnetic material. A winding 104 is wound around a center post 106 of drum magnetic core 102. Magnetic flux flow is approximated by lines 108. As illustrated, drum magnetic core 102 is “unshielded” in the sense that magnetic flux flows outside of drum core 102 at the inductor's perimeter. Magnetic flux flowing through air at the inductor's perimeter may couple to nearby circuitry and cause undesirable electromagnetic interference and/or power losses.

### SUMMARY

In an embodiment, a low-height coupled inductor having length, width, and height includes a composite magnetic core including: (1) first and second magnetic plates separated from each other in the height direction, and (2) a plurality of coupling teeth connecting the first and second magnetic plates in the height direction. The plurality of coupling teeth are formed of magnetic material having a lower magnetic permeability than magnetic material forming the first and second magnetic plates. The low-height coupled inductor further includes a respective winding wound around each of the plurality of coupling teeth.

In an embodiment, a low-height coupled inductor having length, width, and height includes a composite magnetic core including: (1) first and second magnetic plates separated from each other in the height direction, and (2) first and second coupling teeth each connecting the first and second magnetic plates in the height direction. The first and second magnetic plates and the first and second coupling teeth collectively form a passageway extending through the magnetic core in the widthwise direction. The first and second coupling teeth are formed of magnetic material having a lower magnetic permeability than magnetic material forming the first and second magnetic plates. The low-height coupled inductor further includes first and second windings wound around the first magnetic plate and through the passageway.

In an embodiment, a low-height coupled inductor having length, width, and height includes a composite magnetic core including: (1) a magnetic plate and (2) a coupling magnetic structure disposed on an outer surface of the magnetic plate. The coupling magnetic structure is formed of magnetic material having a lower magnetic permeability than magnetic material forming the magnetic plate. The low-height coupled inductor further includes a plurality of windings, each of the plurality of windings forming a respective winding turn on the outer surface of the magnetic plate.

In an embodiment, a method for forming a low-height inductor including a composite magnetic core includes the steps of: (1) disposing a plurality of windings on a first magnetic plate formed of a high permeability magnetic material, such that each of the plurality of windings forms a turn on an outer surface of the first magnetic plate; (2) disposing a low permeability magnetic material within each winding turn on the outer surface of the first magnetic plate, to form a plurality of coupling teeth; and (3) disposing a second magnetic plate formed of a high permeability magnetic material on the plurality of coupling teeth.

In an embodiment, a method for forming a low-height inductor including a composite magnetic core includes the steps of: (1) disposing a plurality of windings on a magnetic plate formed of a high permeability magnetic material, such that each of the plurality of windings forms a winding turn on an outer surface of the magnetic plate; and (2) disposing a coupling magnetic structure formed of a low permeability magnetic material on the outer surface of the magnetic plate.

### BRIEF DESCRIPTION OF THE DRAWINGS

FIG. 1 is a side plan view of a prior-art inductor including a drum magnetic core.

FIG. 2 is a side plan view of a low-height coupled inductor including a composite magnetic core, according to an embodiment.

FIG. 3 is a top plan view of the FIG. 2 low-height coupled inductor.

FIG. 4 is a cross-sectional view of the FIG. 2 low-height coupled inductor taken along line 2A-2A of FIG. 2.

FIG. 5 illustrates a method for forming a low-height inductor including a composite magnetic core, according to an embodiment.

FIG. 6 is a side plan view of the low-height coupled inductor of FIG. 2 after windings have been disposed on a first magnetic plate.

FIG. 7 is a side plan view of the low-height coupled inductor of FIG. 2 after coupling teeth have been formed on the first magnetic plate.

FIG. 8 is a side plan view of the low-height coupled inductor of FIG. 2 after a second magnetic plate has been disposed on the coupling teeth.

FIG. 9 is a side plan view of the low-height coupled inductor of FIG. 2, illustrating approximate magnetic flux paths.

FIG. 10 is a side plan view of an alternate embodiment of the FIG. 2 low-height coupled inductor including low permeability magnetic material in portions of the coupled inductor that are between magnetic plates but outside of winding turns.

FIG. 11 is a side plan view of a low-height coupled inductor which is similar to that of FIGS. 2-4, but further including a third coupling tooth and associated winding, according to an embodiment.

FIG. 12 is a perspective view of a low-height coupled inductor which is similar to that of FIG. 11, but where winding solder tabs extend away from the magnetic core, according to an embodiment.

FIG. 13 is a perspective view of one winding instance of the FIG. 12 low-height coupled inductor, when separated from the remainder of the coupled inductor.

FIG. 14 shows side plan views of the low-height coupled inductors of each of FIGS. 2 and 12.

FIG. 15 is a top plan view of a stamped conductor prior to being bent to form a winding of the FIG. 12 low-height coupled inductor.

FIG. 16 is a perspective view of another low-height coupled inductor which is similar to that of FIG. 2, but including a winding assembly in place of individual windings, according to an embodiment.

FIG. 17 is a perspective view of the winding assembly of the FIG. 16 low-height coupled inductor when separated from the remainder of the coupled inductor.

FIG. 18 is a top plan view of a stamped conductor prior to being bent to form the winding assembly of the FIG. 16 low-height coupled inductor.

FIG. 19 is a perspective view of a low-height coupled inductor including a composite magnetic core and staple-style windings, according to an embodiment.

FIG. 20 is a side plan view of the FIG. 19 low-height coupled inductor.

FIG. 21 is a perspective view of the winding assembly of the FIG. 19 low-height coupled inductor, when separated from the remainder of the coupled inductor.

FIG. 22 is a top plan view of a stamped conductor prior to being bent to form the winding assembly of the FIG. 19 low-height coupled inductor.

FIG. 23 shows one possible footprint for use with the FIG. 19 low-height coupled inductor in a buck converter application, according to an embodiment.

FIG. 24 is a perspective view of another low-height coupled inductor including a composite magnetic core and staple-style windings, according to an embodiment.

FIG. 25 is a side plan view of the FIG. 24 low-height coupled inductor.

FIG. 26 is a perspective view of the winding assembly of the FIG. 24 low-height coupled inductor, when separated from the remainder of the coupled inductor.

FIG. 27 is a top plan view of a stamped conductor prior to being bent to form the winding assembly of the FIG. 24 low-height coupled inductor.

FIG. 28 shows one possible footprint for use with the FIG. 24 low-height coupled inductor in a buck converter application, according to an embodiment.

FIG. 29 is a top plan view of a low-height coupled inductor including a composite magnetic core including a magnetic plate and a coupling magnetic structure, according to an embodiment.

FIG. 30 is a side plan view of the FIG. 29 low-height coupled inductor.

FIG. 31 is a cross-sectional view of the FIG. 29 low-height coupled inductor taken along line 30A-30A of FIG. 30.

FIG. 32 is a side plan view of the low-height coupled inductor of FIG. 29, illustrating approximate magnetic flux paths.

FIG. 33 is a top plan view of another low-height coupled inductor including a composite magnetic core including a magnetic plate and a coupling magnetic structure, according to an embodiment.

FIG. 34 is a side plan view of the FIG. 33 low-height coupled inductor.

FIG. 35 is a side plan view of the low-height coupled inductor of FIG. 33, illustrating approximate magnetic flux paths.

FIG. 36 illustrates a method for forming a low-height inductor including a composite magnetic core including a magnetic plate and a coupling magnetic structure, according to an embodiment.

FIG. 37 is a side plan view of the low-height coupled inductor of FIG. 33 after windings have been disposed on a first magnetic plate.

FIG. 38 is a side plan view of the low-height coupled inductor of FIG. 33 after leakage control structures have been disposed on the magnetic plate.

FIG. 39 is a side plan view of the low-height coupled inductor of FIG. 33 after a coupling magnetic structure has been disposed on an outer surface of the magnetic plate and on the leakage control structures.

FIG. 40 illustrates a multi-phase buck converter including the low-height coupled inductor of FIG. 2, according to an embodiment.

### DETAILED DESCRIPTION OF THE EMBODIMENTS

Applicant has discovered that one or more of the problems discussed above can be at least partially overcome by forming a low-height inductor using a composite magnetic core. In certain embodiments, the composite magnetic core includes two magnetic plates formed of ferrite or other high permeability magnetic material, along with coupling teeth formed of a low permeability magnetic material, such as a matrix of magnetic powder and a binder. This composite structure enables the majority of the core to be formed of a high permeability magnetic material having simple shapes, such as rectangular shapes, thereby helping achieve large inductance values and ease of manufacturing, while still allowing flexibility to achieve desired magnetic core features.

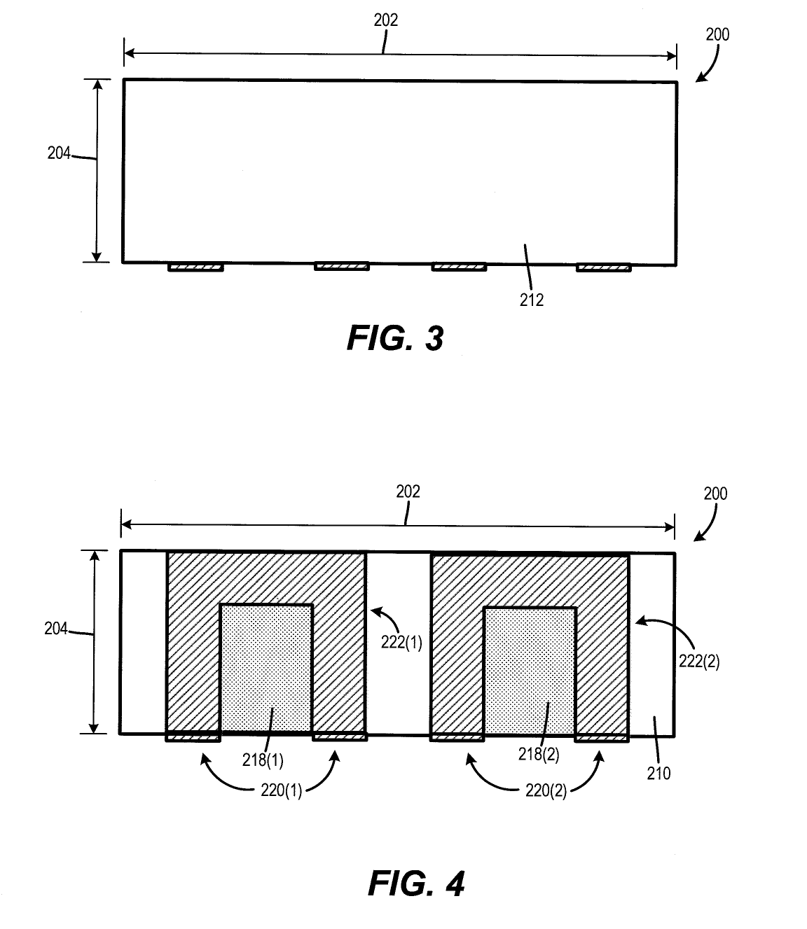

FIGS. 2-4 illustrate one example of a low-height coupled inductor including a composite magnetic core. FIG. 2 is a side plan view of a low-height coupled inductor 200, FIG. 3 is a top plan view of low-height coupled inductor 200, and FIG. 4 is a cross-sectional view of low-height coupled inductor 200 taken along line 2A-2A of FIG. 2. Low-height coupled inductor 200 has a length 202, a width 204, and a height 206. In some embodiments, height 206 is less than 0.75 millimeters.

Low-height coupled inductor 200 includes a composite magnetic core 208 including a first magnetic plate 210 and a second magnetic plate 212 separated from and opposing each other in the height 206 direction. First and second magnetic plates 210, 212 are each formed of a high permeability magnetic material, such as a ferrite material. Although it is anticipated that first and second magnetic plates 210, 212 will typically have the same configuration, e.g., the same composition and the same size, first magnetic plate 210 could differ from second magnetic plate 212 without departing from the scope hereof. First and second magnetic plates 210, 212 are typically smooth and devoid of mechanical features, such as cut-outs or teeth, to facilitate manufacturability and forming the plates with small respective thicknesses 214, 216 in the height direction. In some embodiments, first and second magnetic plates 210, 212 are each rectangular plates with planar outer surfaces.

Composite magnetic core 208 further includes a plurality of coupling teeth 218, where each coupling tooth 218 is disposed between, and connects, first and second magnetic plates 210, 212 in the height 206 direction. Accordingly, composite magnetic core 208 has a “ladder” shape, where first and second magnetic plates 210, 212 are analogous to ladder rails, and coupling teeth 218 are analogous to ladder rungs. Coupling teeth 218 are formed of a low permeability magnetic material that is different from the respective magnetic material forming each of first and second magnetic plates 210, 212. In some embodiments, coupling teeth 218 are formed of magnetic powder, such as ferrite dust, within a binder including adhesive, filler, epoxy, and/or similar material. In this document, specific instances of an item may be referred to by use of a numeral in parentheses (e.g., coupling tooth 218(1)) while numerals without parentheses refer to any such item (e.g., coupling teeth 218).

A respective winding 220 is wound around each coupling tooth 218, so that each winding forms a respective turn 222 around its coupling tooth 218 on an outer surface 224 of first magnetic plate 210. Accordingly, windings 220 are magnetically coupled out-of-phase by composite magnetic core 208. Such out-of-phase magnetic coupling is characterized, for example, by current of increasing magnitude flowing clockwise around one winding turn 222 inducing current of increasing magnitude flowing clockwise around each other winding turn 222, as seen when viewed cross-sectionally in the height 206 direction. Windings 220 are, for example, foil or wire windings. Each winding forms a respective solder tab (not shown) disposed on an outer surface 226 of composite magnetic core 208, where outer surface 226 is opposite of outer surface 224 in the height 206 direction.

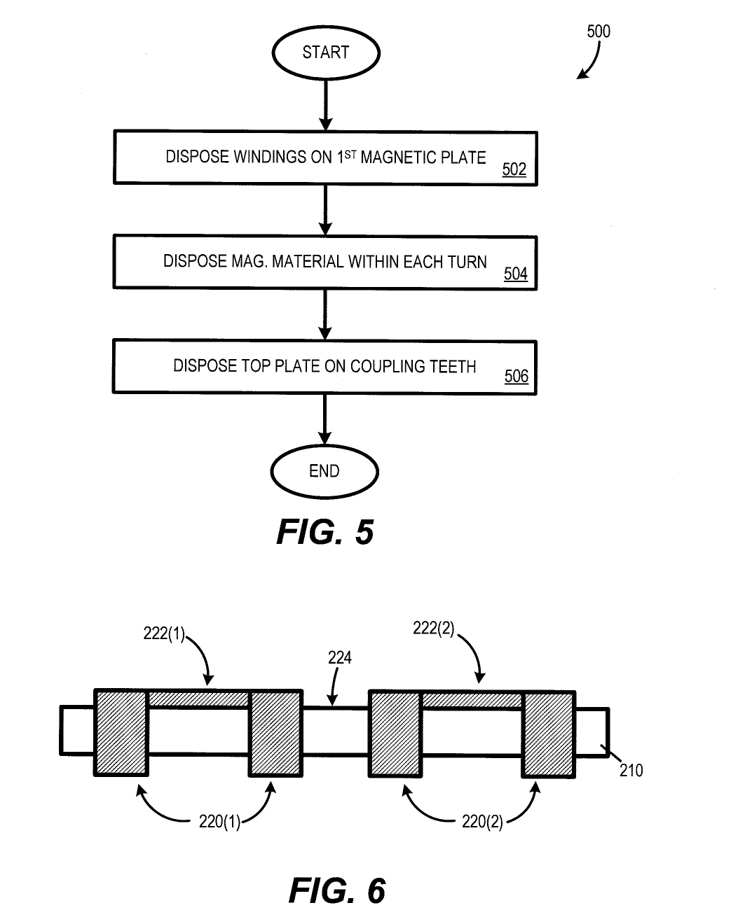

FIG. 5 illustrates a method 500 for forming a low-height inductor including a composite magnetic core. Method 500 is used, for example, to form low-height coupled inductor 200 of FIGS. 2-4, and FIGS. 6-8 illustrate one example of using method 500 to form this low-height coupled inductor. It should be appreciated, however, that method 500 could be used to form other low-height inductors. Additionally, low-height coupled inductor 200 could be formed by a method other than method 500.

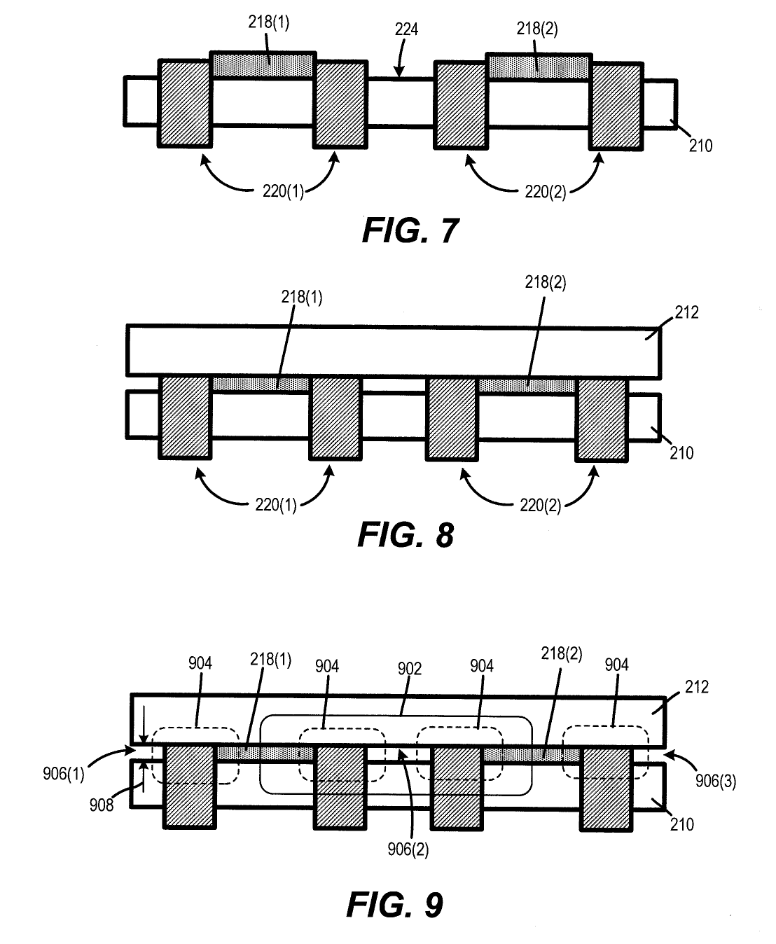

In step 502, one or more windings are disposed on a first magnetic plate formed of a high permeability magnetic material, such that each winding forms a turn on an outer surface of the first magnetic plate. In one example of step 502, windings 220 are disposed on first magnetic plate 210, such that each winding 220 forms a respective turn 222 on outer surface 224 as illustrated in FIG. 6. In step 504, low permeability magnetic material is disposed within each winding turn on the outer surface of the first magnetic plate, to form a plurality of coupling teeth. In one example of step 504 illustrated in FIG. 7, powder magnetic material within a binder, such as in the form of magnetic paste, is disposed on outer surface 224 within each winding turn 222 to form coupling teeth 218. In step 506, a second magnetic plate formed of high permeability magnetic material is disposed on the coupling teeth formed in step 504. In some embodiments, the second magnetic plate is secured, such as by glue and/or by curing, to the remainder of the low-height inductor. In one example of step 506, second magnetic plate 212 is disposed on coupling teeth 218, as illustrated in FIG. 8.

Low-height coupled inductor 200 may achieve one or more significant advantages over conventional low-height inductors. For example, the fact that first and second magnetic plates 210, 212 are formed of a high permeability magnetic material, such as a ferrite magnetic material, results in a significant portion of composite magnetic core 208's volume being formed of high permeability magnetic material. Consequentially, low-height coupled inductor 200 may potentially achieve large inductance values with windings 220 having a small number of turns, since inductance is proportional to magnetic permeability. Indeed, in some embodiments, windings 220 are single-turn windings, such as illustrated herein. A small number of winding turns helps achieve low winding DCR because DCR is proportional to winding length. Accordingly, certain embodiments of low-height coupled inductor 200 achieve both large inductance values and low winding DCR. Multilayer film low-height inductors, in contrast, typically cannot realize both large inductance values and low DCR, as discussed above.

As another example, the configuration of composite magnetic core 208 helps promote ease of manufacturing while still allowable flexibility to achieve magnetic core features. In particular, high permeability magnetic materials, such as ferrite materials, are typically fragile. Thus, the more complicated the shape of a high permeability magnetic element, the more likely the magnetic element is to break during manufacturing. In composite magnetic core 208, though, first and second magnetic plates 210, 212, which are formed of a high permeability material, have simple shapes, such as rectangular shapes, thereby promoting robustness of these plates and high manufacturing yield. Additionally, magnetic core features can be achieved through coupling teeth 218, or other low permeability magnetic core elements disposed between first and second plates 210, 212. Low permeability magnetic material is typically significantly less fragile than high permeability magnetic material. Thus, coupling teeth, or other low permeability magnetic elements, can potentially be disposed between first and second plates 210, 212 in the height 206 direction without significantly decreasing robustness of composite magnetic core 208. Accordingly, the configuration of magnetic core 208 allows the magnetic core to include multiple coupling teeth, thereby supporting inverse magnetic coupling of multiple windings 220, while allowing high permeability material portions to retain simple shapes.

Modifications could be made to low-height coupled inductor 200 without departing from the scope hereof. For example, additional coupling tooth 218 and winding 220 pairs could be added, so that low-height coupled inductor 200 includes additional windings, or in other words, supports additional “phases” in a multiphase DC-to-DC converter application. Conversely, one coupling tooth 218 and winding 220 pair could be omitted, so that the inductor is a discrete, or uncoupled, inductor. As another example, windings 220 could be multi-turn windings, and/or first and second magnetic plates could be non-rectangular plates. Additionally, in some alternate embodiments, two or more coupling teeth 218 have different length by width cross-sectional areas, and/or at least two of windings 220 form different numbers of turns around respective coupling teeth 218, to achieve an asymmetrical coupled inductor.

FIG. 9 is a side plan view of low-height coupled inductor 200 illustrating approximate magnetic flux paths. Solid line 902 illustrates an approximate coupling magnetic flux path, and dashed lines 904 illustrate approximate leakage magnetic flux paths. Coupling magnetic flux magnetically links windings 220 together, and coupling magnetic flux is therefore associated with energy transfer between windings 220. Leakage magnetic flux, on the other hand, only links a single winding 220, and leakage magnetic flux is therefore associated with leakage inductance and energy storage of the winding. As illustrated, both magnetizing magnetic flux and leakage magnetic flux pass through coupling teeth 218. Only leakage flux, though, passes between first magnetic plate 210 and second magnetic plate 212 in portions 906 outside of winding turns 222. Consequentially, leakage inductance can be tuned during design of low-height coupled inductor 200 by adjusting the dimensions of portions 906. For example, leakage inductance can be increased by increasing lengthwise 202 by widthwise 204 area of portions 906, or by decreasing a separation distance 908 between first and second magnetic plates 210, 212 in the height 206 direction, to reduce leakage path reluctance.

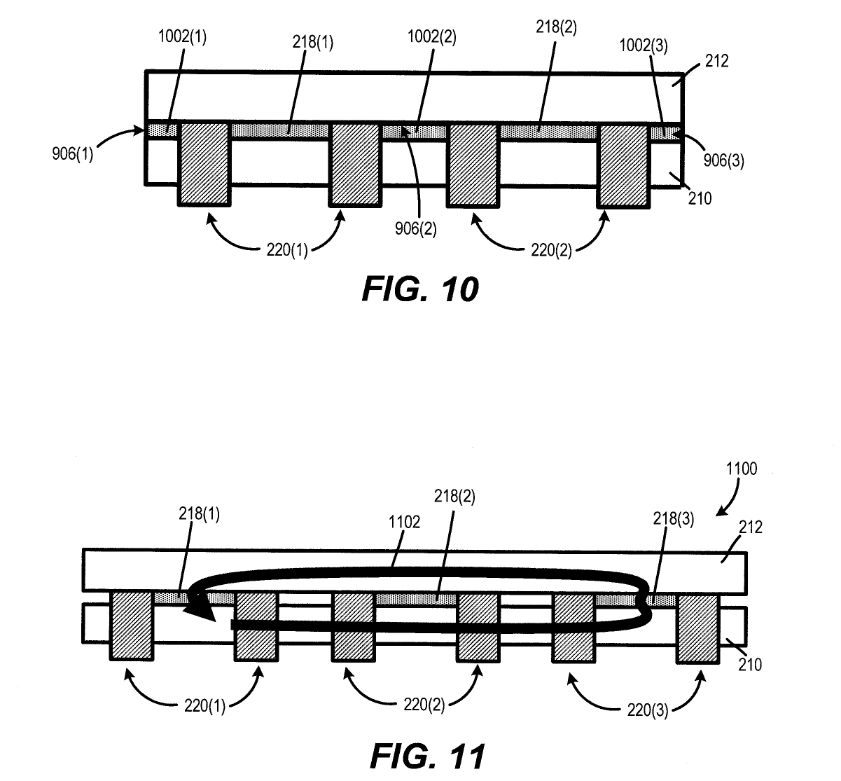

In some alternate embodiments, low permeability magnetic material 1002 is disposed in some or all of one or more of portions 906, as illustrated in FIG. 10, such as to provide additional magnetic shielding of windings 220 and/or to achieve desired leakage inductance values. Although magnetic permeability of magnetic material 1002 is relatively low, it is much greater than magnetic permeability of air. As a result, use of low permeability magnetic material 1002 in portions 906 promotes large leakage inductance. In some embodiments, low permeability magnetic material 1002 has the same composition as the low permeability magnetic material forming coupling teeth 218, to promote manufacturing simplicity. In some other embodiments, low permeability magnetic material 1002 has a different composition than the low permeability magnetic material forming coupling teeth 218, such as to achieve desired leakage inductance values. For example, in a particular embodiment, magnetic material 1002 has a lower magnetic permeability than the magnetic material forming coupling teeth 218.

It should be appreciated that high permeability of first and second magnetic plates 210, 212 helps achieve a low reluctance coupling path between all coupling teeth 218, even if coupling teeth 218 are significantly separated from each other, so that all winding 220 instances are strongly magnetically coupled. Consider, for example, FIG. 11, which illustrates a side plan view of a low-height coupled inductor 1100. Low-height coupled inductor 1100 is similar to low-height coupled inductor 200 of FIGS. 2-4, but low-height coupled inductor 1100 includes a third coupling tooth 218 and associated winding 220. The fact that first and second magnetic coupling plates 210, 212 are formed of high permeability magnetic material, such as a ferrite material, helps achieve strong magnetic coupling of all windings, even non-adjacent windings 220(1) and 220(3), as symbolically illustrated by line 1102. Accordingly, use of composite magnetic core 208 helps enable coupled inductor 200 to be scalable, where additional winding 220 and coupling teeth 218 pairs can be added during inductor design, while still achieving strong magnetic coupling between all windings. Additionally, use of composite magnetic core 208 allows adjacent coupling teeth 218 to be significantly spaced apart from each other in the lengthwise 202 direction, to achieve low reluctance leakage paths, while still achieving strong magnetic coupling of windings 220. If composite magnetic core 208 were instead replaced with a monolithic magnetic core formed of low permeability magnetic material, non-adjacent windings, or widely separated windings, would not be significantly magnetically coupled.

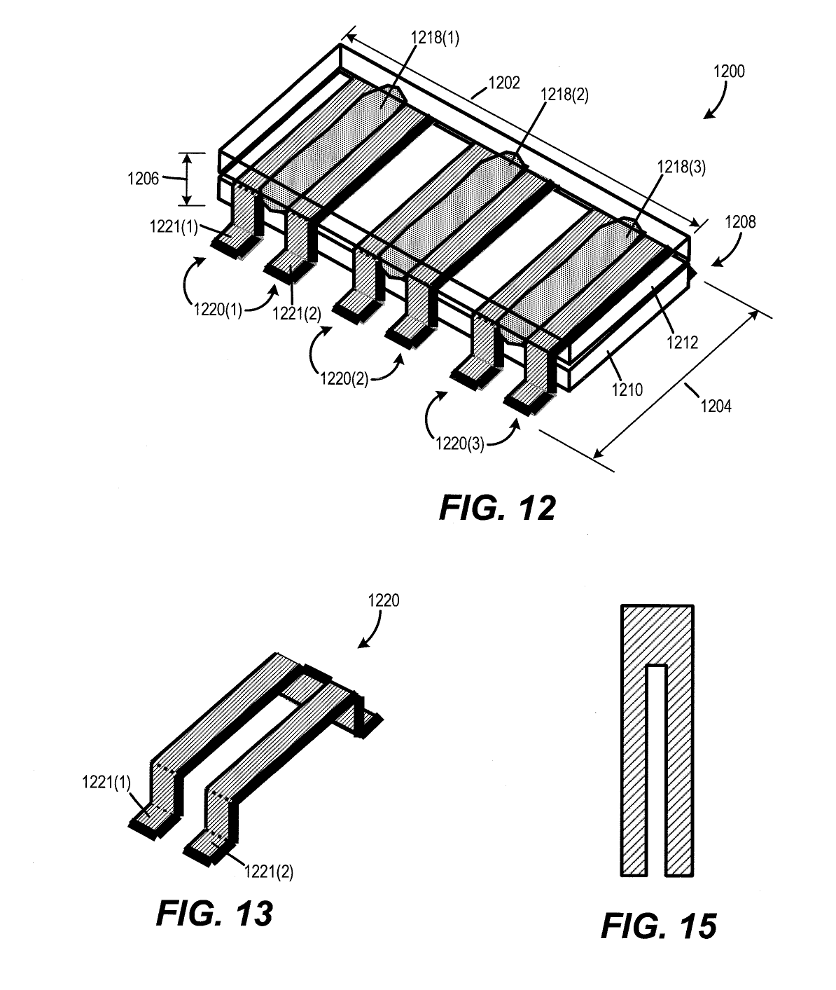

FIG. 12 is a perspective view of a low-height coupled inductor 1200 which is similar to low-height coupled inductor 1100 of FIG. 11, but includes windings 1220 in place of windings 220. Low-height coupled inductor 1200 has a length 1202, a width 1204, and a height 1206. Low-height coupled inductor 1200 includes a composite magnetic core 1208 in place of composite magnetic core 208. Similar to composite magnetic core 208, composite magnetic core 1208 includes a first magnetic plate 1210 and a second magnetic plate 1212, each formed of high permeability magnetic material, such as a ferrite magnetic material. Only the outline of second magnetic plate 1212 of composite magnetic core 1208 is shown in FIG. 12 to show windings 1220 within low-height coupled inductor 1200. First and second magnetic plates 1210, 1212 are separated from each other in the height 1206 direction. Composite magnetic core 1208 further includes a plurality of coupling teeth 1218 formed of low permeability magnetic material. Each coupling tooth 1218 is disposed between, and connects, first and second magnetic plates 1210, 1212 in the height 1206 direction. In contrast with composite magnetic core 208, however, each coupling tooth 1218 extends at least substantially along an entire width 1204 of the magnetic core.

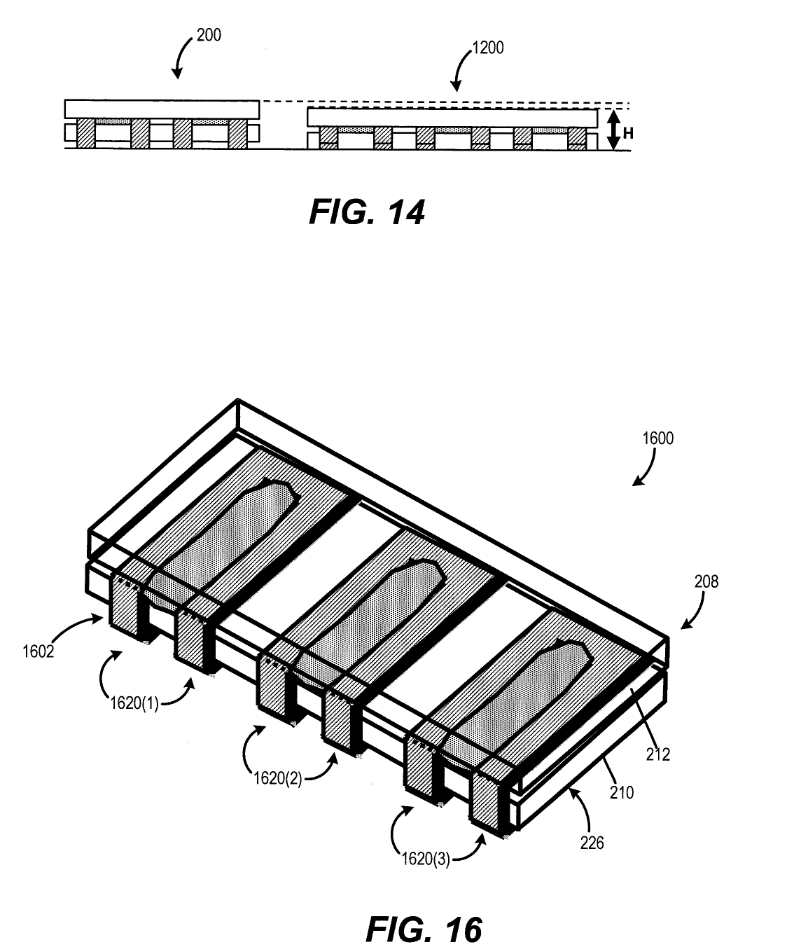

FIG. 13 shows a perspective view of one winding 1220 instance when separated from the remainder of low-height coupled inductor 1200. Opposing ends of each winding 1220 form respective solder tabs which extend away from magnetic core 1208 in the widthwise 1204 direction, so that the solder tabs 1221 do not increase height 1206. Only some instances of solder tabs 1221 are labeled in FIG. 12 to promote illustrative clarity. In low-height coupled inductor 200 of FIGS. 2-4, in contrast, windings 220 form solder tabs along bottom outer surface 226 of composite magnetic core 208, and windings 220 thereby increasing height 206 (see FIG. 2). FIG. 14 show side plan views of low-height coupled inductors 200 and 1200 side-by-side, thereby illustrating one possible reduction in height achievable by use of windings 1220 in place of windings 220. Some or all of a height reduction achieved by use of windings 1220 may be traded-off for thicker first and second magnetic plates 1210, 1212, and/or for thicker windings 1220. In some embodiments, windings 1220 are formed by stamping conductive material in the shape of FIG. 15, and then bending the stamped shaped to form the winding of FIG. 13.

Control of winding 220 position during manufacturing of low-height coupled inductor 200 may be important. For example, windings 220 must be in their proper locations on first magnetic plate 210 ensure matching of low-height coupled inductor 200 to its intended printed circuit board footprint, to prevent shorting of adjacent windings, to achieve symmetrical leakage inductance values associated with windings 220, etc. When windings are disposed on a magnetic plate before forming coupling teeth 218, such as in method 500 of FIG. 5, the windings may move during the manufacturing process.

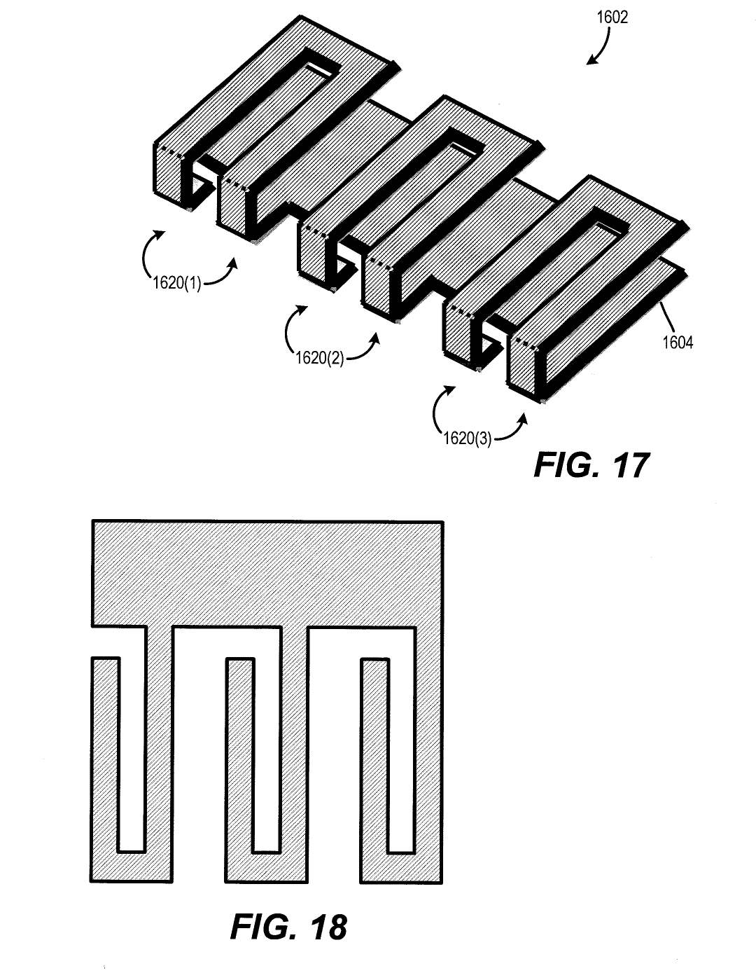

To help overcome this possible drawback, Applicant has developed single-piece winding assemblies which control the position of windings with respect to each other. In particular, in these assemblies, the windings are joined together so that the relative positions of the windings are fixed. Thus, winding position can be controlled during low-height coupled inductor manufacturing simply by controlling the position of the winding assembly, thereby easing manufacturing. FIG. 16 is a perspective view of a low-height coupled inductor 1600, which is similar to low-height coupled inductor 200 of FIG. 2, but includes a winding assembly 1602 in place of individual windings 220. Only the outline of second magnetic plate 212 is shown as transparent in FIG. 16 to partially show winding assembly 1602. FIG. 17 is a perspective view of winding assembly 1602 separated from the remainder of low-height coupled inductor 1600. Winding assembly 1602 includes a plurality of windings 1620 joined by a common terminal or tab 1604 (see FIG. 17). Common tab 1604 is disposed on outer surface 226 of composite magnetic core 208. The relatively large size of common tab 1604 advantageously (1) provides a low-resistance electrical connection to one end of each winding 1620, (2) helps transfer heat away from low-height coupled inductor 1600, and (3) promotes mechanical robustness of low-height coupled inductor 1600. In some embodiments, winding assembly 1602 is formed by stamping a conductive material, such as copper, to have a shape shown in FIG. 18, and then bending the stamped shape to form the assembly of FIG. 17.

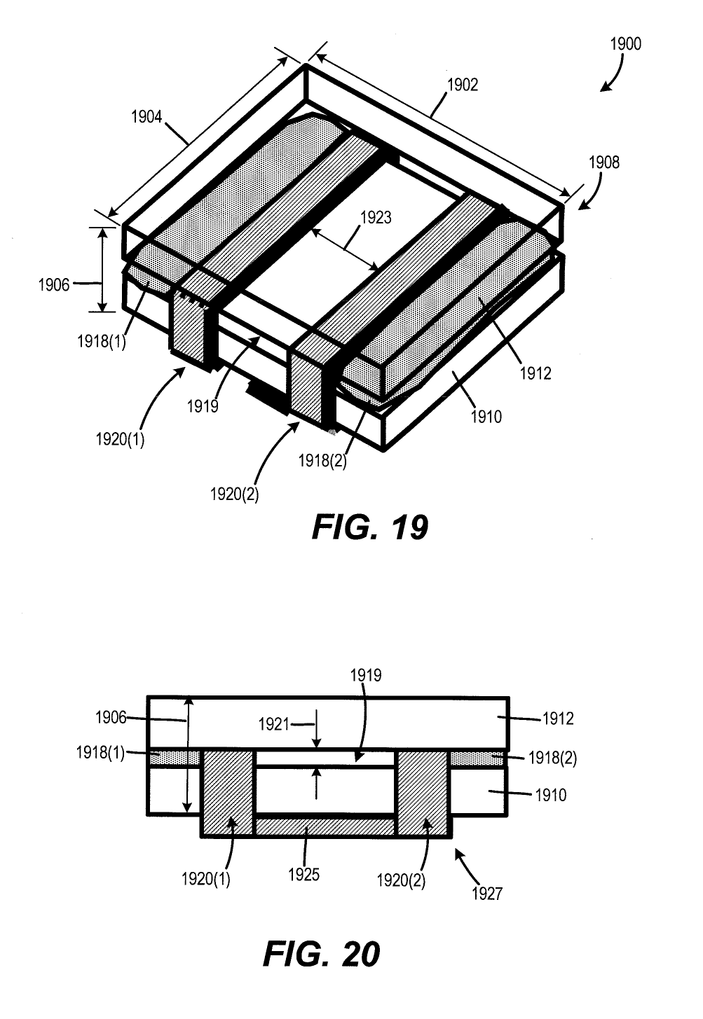

FIG. 19 is a perspective view of a low-height coupled inductor 1900 having a length 1902, a width 1904, and a height 1906. In some embodiments, height 1906 is less than 0.75 millimeters. FIG. 20 shows a side plan view of low-height coupled inductor 1900.

Low-height coupled inductor 1900 includes a composite magnetic core 1908, which is similar to composite magnetic core 208 of FIGS. 2-4. In particular, composite magnetic core 1908 includes a first magnetic plate 1910 and a second magnetic plate 1912 separated from and opposing each other in the height 1906 direction. Only the outline of second magnetic plate 1912 is shown in FIG. 19 to partially show the interior of low-height coupled inductor 1900.

First and second magnetic plates 1910, 1912 are each formed of a high permeability magnetic material, such as a ferrite material. Although it is anticipated that first and second magnetic plates 1910, 1912 will typically have the same configuration, e.g., the same composition and the same size, first magnetic plate 1910 could differ from second magnetic plate 1912 without departing from the scope hereof. First and second magnetic plates 1910, 1912 are typically smooth and devoid of mechanical features, such as cut-outs or teeth, to facilitate manufacturability and forming the plates with small respective thicknesses in the height direction. In some embodiments, first and second magnetic plates 1910, 1912 are each rectangular plates with planar outer surfaces.

Composite magnetic core 1908 further includes two coupling teeth 1918, where each coupling tooth 1918 is disposed between, and connects, first and second magnetic plates 1910, 1912 in the height 1906 direction. Coupling teeth 1918 are formed of a low permeability material that is different from the respective magnetic material forming each of first and second magnetic plates 1910, 1912. In some embodiments, coupling teeth 1918 are formed of magnetic powder, such as ferrite dust, within a binder including adhesive, filler, epoxy, and/or similar material. Coupling teeth 1918 and first and second magnetic plates 1910, 1912 collectively form a passageway 1919 extending through composite magnetic core 1908 in the widthwise 1904 direction. Passageway 1919 has a height 1921, as illustrated in FIG. 20.

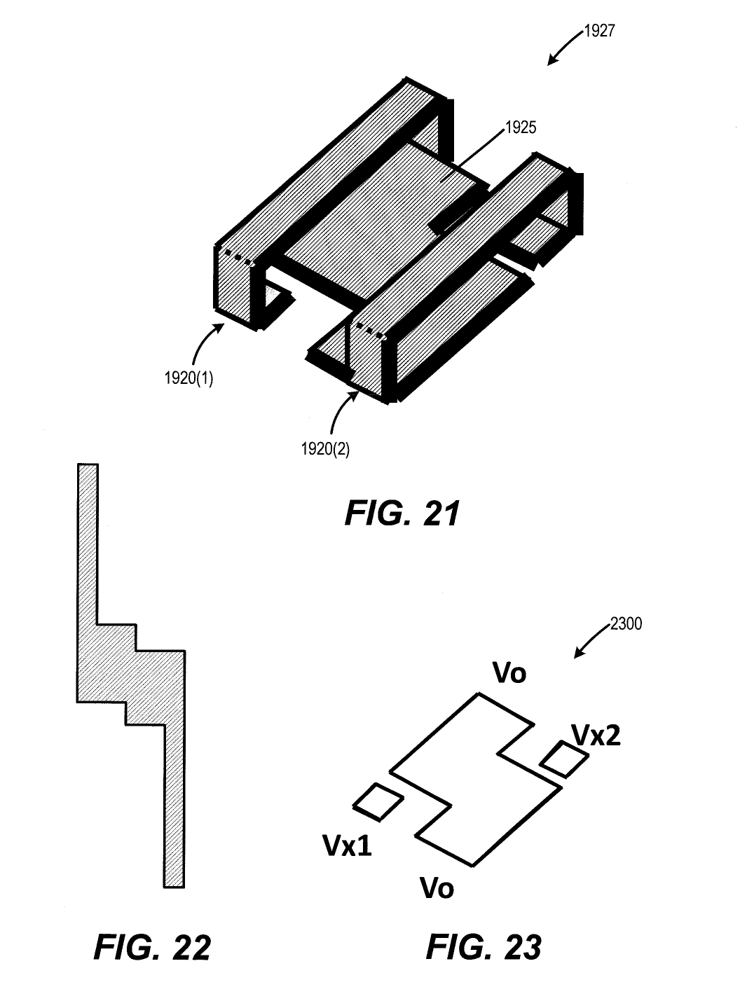

Two staple-style windings 1920 are wound around first magnetic plate 1910, such that each winding extends through passageway 1919 in the widthwise 1904 direction. Windings 1920 are separated from each other by a linear separation distance 1923 in the lengthwise 1902 direction throughout passageway 1919 (see FIG. 19). In some embodiments, windings 1920 are joined by a common terminal or tab 1925 to form a winding assembly 1927, as illustrated in FIGS. 19 and 20. FIG. 21 is a perspective view of winding assembly 1927 when separated from the remainder of low-height coupled inductor 1900. Use of winding assembly 1927, instead of discrete windings, promotes ease of manufacturing in a manner similar to that discussed above with respect to FIGS. 16-18. In some embodiments, winding assembly 1927 is formed by stamping a conductive material, such as copper, to have a shape shown in FIG. 22, and then bending the stamped shape to form the assembly of FIG. 21. FIG. 23 shows one possible footprint 2300 for use with low-height coupled inductor 1900 in a buck converter application. In FIG. 23, Vx1 and Vx2 refer to first and second switching nodes, respectively, and Vo refers to an output node. Low height coupled inductor 1900 is optionally formed by a method similar to that of FIG. 5.

Coupling magnetic flux and leakage flux pass through coupling teeth 1918. Only leakage magnetic flux, though, passes through passageway 1919. Consequentially, leakage inductance can be tuned during design of low-height coupled inductor 1900 by adjusting the dimensions of passageway 1919. For example, leakage inductance can be increased by increasing separation distance 1923 and/or by decreasing passageway height 1921, to decrease the leakage path reluctance. In some embodiments, separation distance 1923 is greater than passageway height 1921 to obtain relatively large leakage inductance values. Leakage inductance can be further increased by partially or completely filling passageway 1919 with magnetic material (not shown), such as magnetic material having a lower permeability that the magnetic material forming coupling teeth 1918.

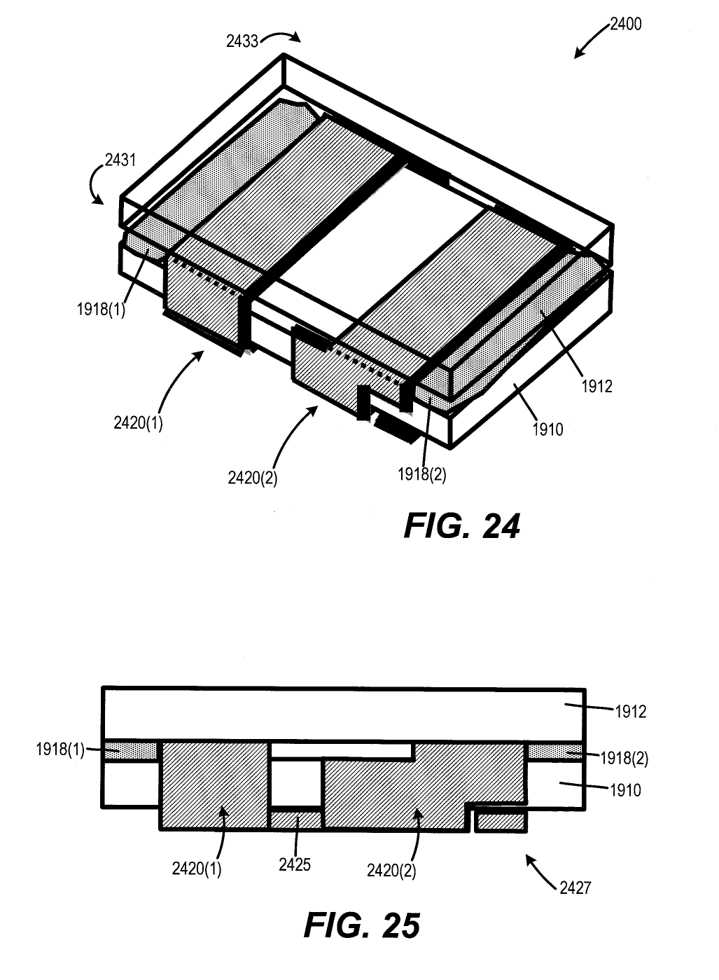

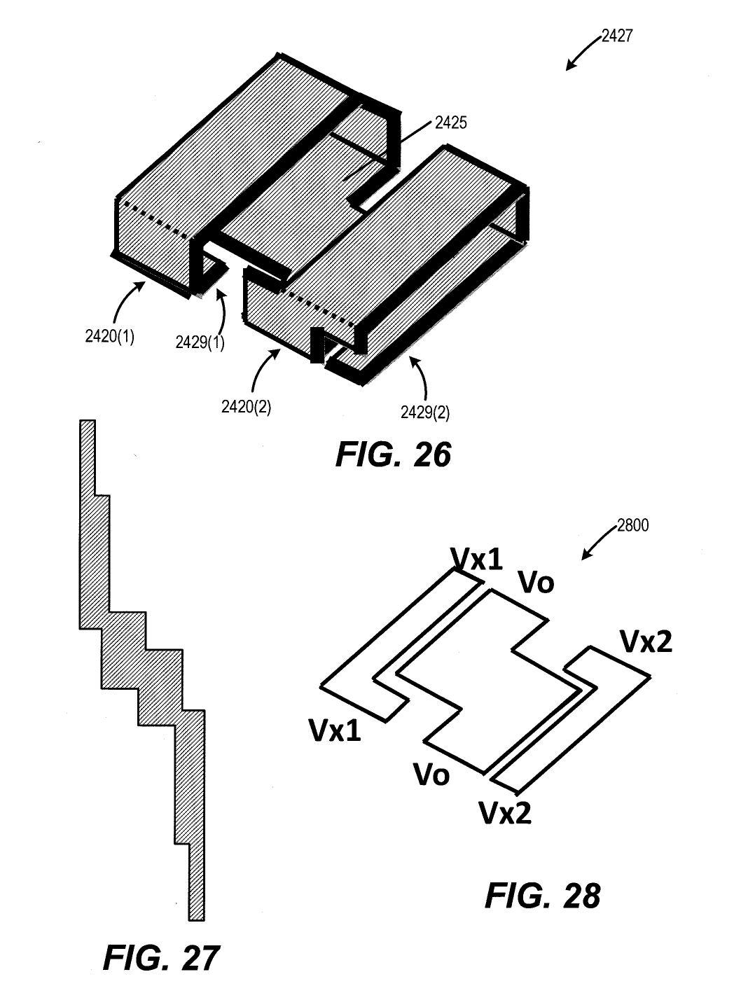

FIG. 24 is a perspective view, and FIG. 25 is a side plan view, of another low-height coupled inductor including a composite magnetic core and staple-style windings. Only the outline of second magnetic plate 1912 is shown in FIG. 24 to show the interior of coupled inductor 2400. Low-height coupled inductor 2400 of FIGS. 24 and 25 is similar to low-height coupled inductor FIGS. 19 and 20, but coupled inductor 2400 includes winding assembly 2427 in place of winding assembly 1927. Winding assembly 2427 includes two staple-style windings 2420 joined by a common terminal or tab 2425. FIG. 26 is a perspective view of winding assembly 2427 when separated from the remainder of low-height coupled inductor 2400. In some embodiments, winding assembly 2427 is formed by stamping a conductive material, such as copper, to have a shape shown in FIG. 27, and then bending the stamped shape to form the assembly of FIG. 26.

The distal ends of each winding 2420 forms a respective solder tab 2429 having an L-shaped, thereby potentially enabling switching nodes connections to be made on both of opposing sides 2431 and 2433 of low-height coupled inductor 2400. For example, FIG. 28 shows one possible footprint 2800 for use with low-height coupled inductor 2400 in a buck converter application. As illustrated, connections to first and second switching nodes Vx1 and Vx2 can be made on both sides of the footprint.

In the exemplary embodiments discussed above, the composite magnetic core includes separate first and second magnetic plates. While this configuration has significant advantages, Applicant has discovered that inductor cost and/or height can be even further reduced, with the possible tradeoff of reduced inductance, by replacing one of the magnetic plates with a coupling magnetic structure formed of low permeability magnetic material.

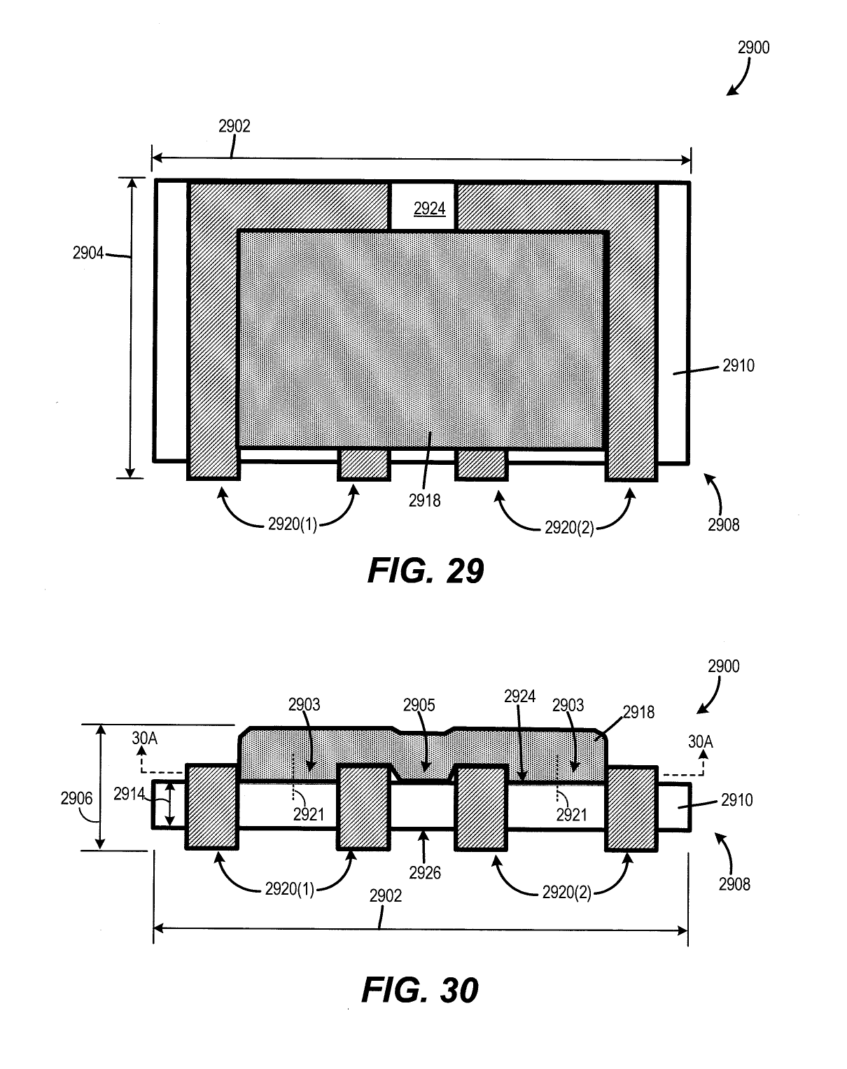

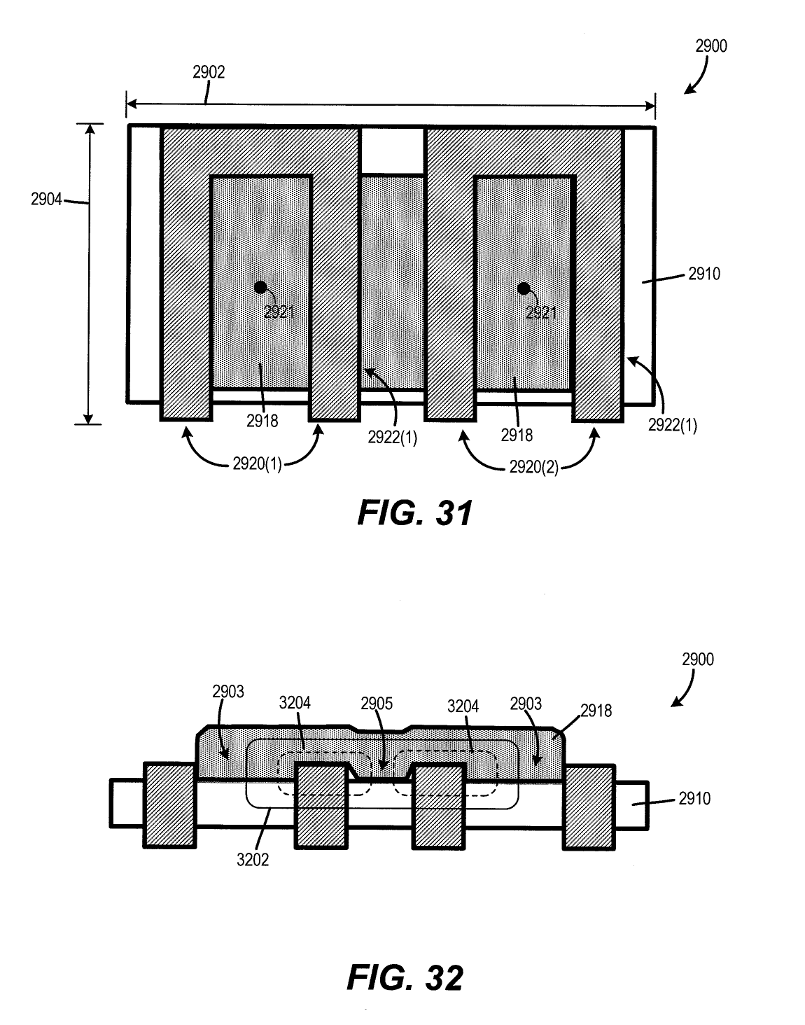

For example, FIG. 29 is a top plan view and FIG. 30 is a side plan view of a low-height coupled inductor 2900. FIG. 31 is a horizontal cross-sectional view taken along line 30A-30A of FIG. 30. Low-height coupled inductor 2900 has a length 2902, a width 2904, and a height 2906. In some embodiments, height 2906 is less than 1.5 millimeters.

Low-height coupled inductor 2900 includes a composite magnetic core 2908 and two windings 2920. Composite magnetic core 2908 includes a magnetic plate 2910 and a coupling magnetic structure 2918. Windings 2920 are, for example, foil or wire windings. Each winding 2920 forms a winding turn 2922 around a respective center axis 2921, on an outer surface 2924 of first magnetic plate 2910 (see FIGS. 30 and 31). Each center axis 2921 extends in the height 2906 direction, and each center axis 2921 is offset from each other axis 2921 in the lengthwise 2902 direction. Adjacent winding turns 2922 are separated from each other in the lengthwise direction 2902, so that winding turns 2922 do not overlap with each other, as seen when low-height coupled inductor 2900 is viewed cross-sectionally in the height 2906 direction.

Each winding 2920 forms a respective solder tab (not shown) disposed on an outer surface 2926 of composite magnetic core 2908, where outer surface 2926 is opposite of outer surface 2924 in the height 2906 direction. In some alternate embodiments, however, winding solder tabs extend away from magnetic core 2908 in the widthwise 2904 direction, such as in a manner similar to that of low-height coupled inductor 1200 of FIG. 12, so that the solder tabs do not contribute to height 2906.

Magnetic plate 2910 is formed of a high permeability magnetic material, such as a ferrite material. Magnetic plate 2910 is typically smooth and devoid of mechanical features, such as cut-outs or teeth, to facilitate manufacturability and forming the plate with a small thickness 2914 in the height 2906 direction. In some embodiments, magnetic plate 2910 is a rectangular plate with planar outer surfaces.

Coupling magnetic structure 2918 is disposed on outer surface 2924 of magnetic plate 2910 and provides a path for magnetic flux coupling winding turns 2922. Coupling magnetic structure 2918 and magnetic plate 2910 collectively magnetically couple windings 2920 out-of-phase. Such out-of-phase magnetic coupling is characterized, for example, by current of increasing magnitude flowing clockwise around one winding turn 2922 inducing current of increasing magnitude flowing clockwise around each other winding turn 2922, as seen when viewed cross-sectionally in the height 2906 direction. Material forming coupling magnetic structure 2918 is different from, and has a lower magnetic permeability than, magnetic material forming magnetic plate 2910. In some embodiments, coupling magnetic structure 2918 is formed of magnetic powder, such as ferrite dust, within a binder including adhesive, filler, epoxy, and/or similar material. Coupling magnetic structure 2918 includes portions 2903 within winding turns 2922 and portion 2905 outside winding turns 2922, as seen when low-height coupled inductor 2900 is viewed cross-sectionally in the height 2906 direction.

FIG. 32 is a side plan view of low-height coupled inductor 2900 illustrating approximate magnetic flux paths. Solid line 3202 illustrates an approximate coupling magnetic flux path, and dashed lines 3204 illustrate approximate leakage magnetic flux paths. As illustrated, both magnetizing magnetic flux and leakage magnetic flux pass through portions 2903 of coupling magnetic structure 2918. Only leakage flux, though, passes through portion 2905 of coupling magnetic structure 2918. Consequentially, leakage inductance values can be tuned during design of low-height coupled inductor 2900 by adjusting the dimensions of portions 2905 of coupling magnetic structure 2918. For example, leakage inductance values can be increased by increasing lengthwise 2902 by widthwise 2904 area of portions 2905, to reduce leakage path reluctance.

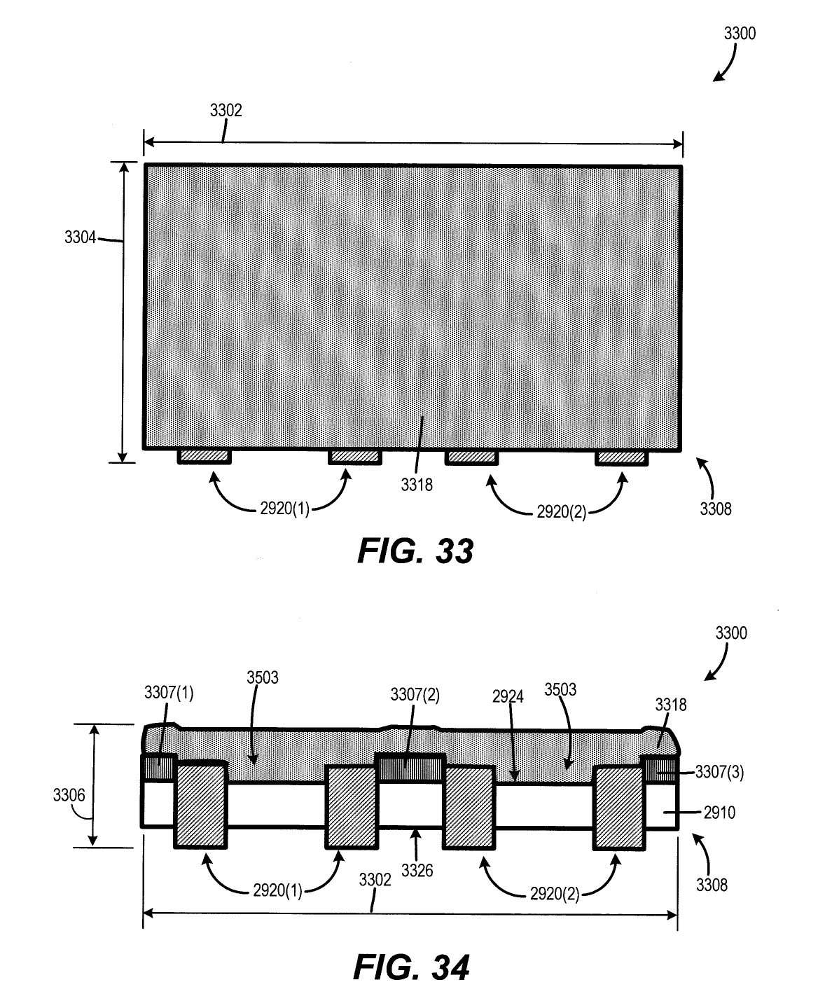

FIG. 33 is a top plan view and FIG. 34 is a side plan view of a low-height coupled inductor 3300, which is similar to low height coupled inductor 2900 of FIG. 29, but further including leakage control structures and a larger coupling magnetic structure. Low-height coupled inductor 3300 has a length 3302, a width 3304, and a height 3306.

Low-height coupled inductor 3300 includes a composite magnetic core 3308 including magnetic plate 2910 and a coupling magnetic structure 3318 in place of coupling magnetic structure 2918. Coupling magnetic structure 3318 covers substantially all of a length 3302 by width 3304 area of magnetic plate 2910 outer surface 2924, thereby facilitating precise control of coupling magnetic structure 3318 thickness during manufacturing. Additionally, the fact that coupling magnetic structure 3318 covers substantially all of outer surface 2924 helps contain magnetic flux to composite magnetic core 3308, thereby helping minimize proximity losses and/or likelihood of electromagnetic interference from stray magnetic flux originating from low-height coupled inductor 3300.

Additionally, low-height coupled inductor 3300 further includes leakage control structures 3307. Each leakage control structure 3307 has a lower magnetic permeability than the respective magnetic materials forming magnetic plate 2910 and coupling magnetic structure 3318. In some embodiments, leakage control structures 3307 are formed of a low permeability magnetic material, while in some other embodiments, leakage control structures 3307 are formed of a non-magnetic material, such as plastic, a ceramic material, adhesive, or even air. Each leakage control structure 3307 is disposed on a respective portion of outer surface 2924 outside of winding turns 2922, as seen when low-height coupled inductor 3300 is viewed cross-sectionally in the height 3306 direction. Accordingly, each leakage control structure 3307 is disposed between magnetic plate 2910 and coupling magnetic structure 3318, in the height 3306 direction.

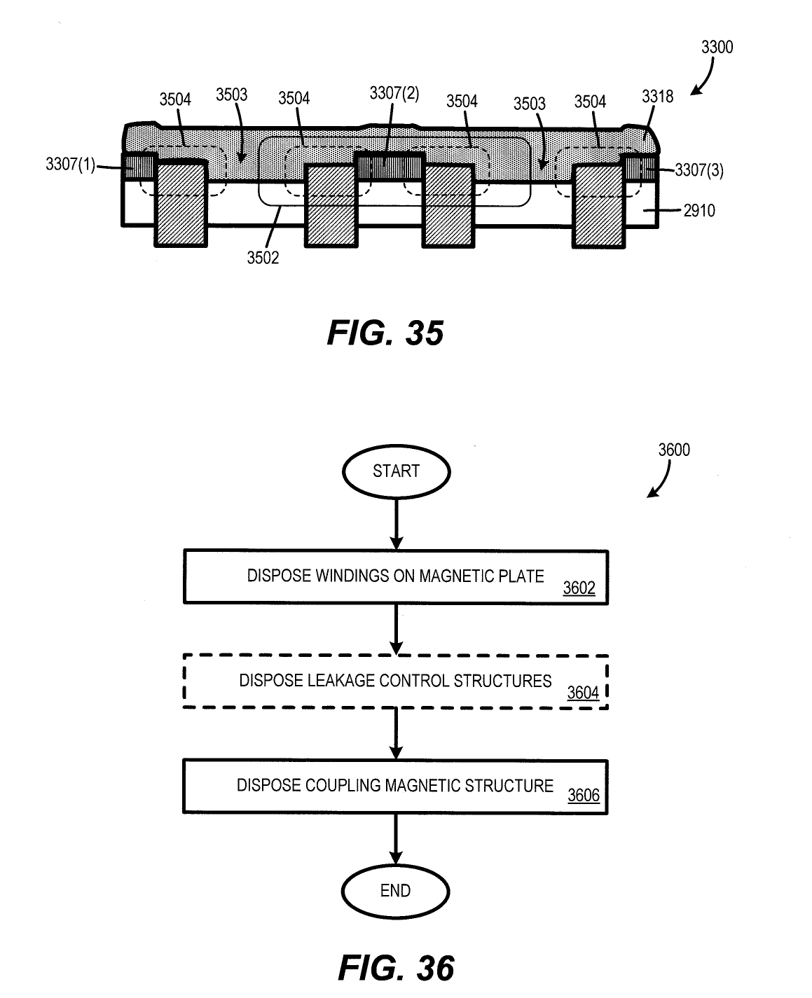

FIG. 35 is a side plan view of low-height coupled inductor 3300 illustrating approximate magnetic flux paths. Solid line 3502 illustrates an approximate coupling magnetic flux path, and dashed lines 3504 illustrate approximate leakage magnetic flux paths. As illustrated, both magnetizing magnetic flux and leakage magnetic flux pass through portions 3503 of coupling magnetic structure 3318 within winding turns 2922. Only leakage flux, though, passes through leakage control structures 3307. Consequentially, leakage inductance values can be tuned during design of low-height coupled inductor 3300 by adjusting composition and/or dimensions of leakage control structures 3307. For example, leakage inductance values can be increased by (1) increasing magnetic permeability of leakage control structures 3307, (2) increasing lengthwise 3302 by widthwise 3304 area of leakage control structures 3307, and/or (3) decreasing height of leakage control structures 3307, to reduce leakage path reluctance.

Modifications could be made to low-height coupled inductors 2900 and 3300 without departing from the scope hereof. For example, although low-height coupled inductors 2900 and 3300 are illustrated with magnetic plate 2910 being on the bottom and magnetic coupling structure 2918 and 3318 being on the top, the positions of the magnetic plate and magnetic coupling structures could be swapped. Additionally, while windings 2920 are illustrated as being single-turn windings, one or more of windings 2920 could alternately form a plurality of winding turns 2922. Furthermore, additional windings 2920 could be added, or one winding could be omitted so that the inductor is a discrete, or uncoupled, inductor. Moreover, magnetic plate 2910 could be a non-rectangular magnetic plate.

Furthermore, in some alternate embodiments of low-height coupled inductors 2900 and 3300, windings 2920 are joined together so that the relative positions of the windings are fixed, such as in a manner similar to that discussed above with respect to FIGS. 16-18. Thus, winding position can be controlled during low-height coupled inductor manufacturing simply by controlling the position of the winding assembly, thereby easing manufacturing. In these alternate embodiments, windings 2920 are part of a common winding assembly (not shown), similar to winding assembly 1602 of FIG. 16, where windings 2920 are joined by a common terminal or tab disposed on outer surface 2926 of composite magnetic core 2908 or on an outer surface 3326 of composite magnetic core 3308.

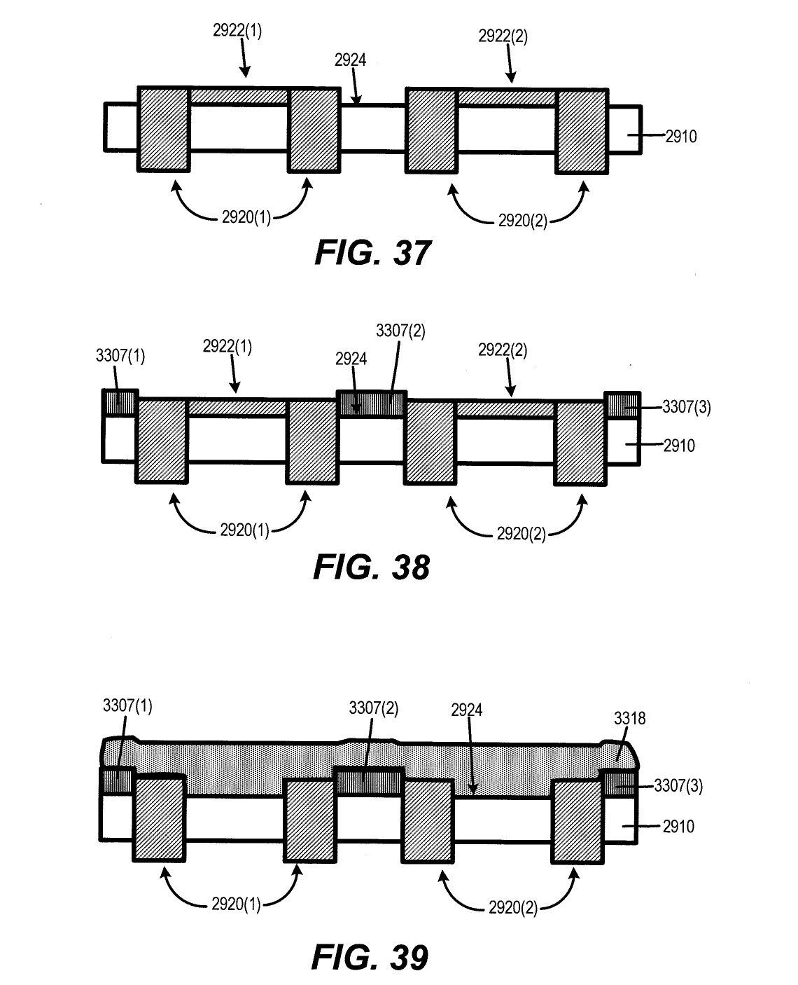

FIG. 36 illustrates a method 3600 for forming a low-height inductor including a composite magnetic core including a single magnetic plate. Method 3600 is used, for example, to form low-height coupled inductor 2900 of FIG. 29 or low-height coupled inductor 3300 of FIG. 33. FIGS. 37-39 illustrate one example of using method 3600 to form low-height coupled inductor 3300. It should be appreciated, however, that method 3600 could be used to form other low-height inductors. Additionally, low-height coupled inductors 2900 and 3600 could be formed by a method other than method 3600.

In step 3602, one or more windings are disposed on a magnetic plate formed of a high permeability magnetic material, such that each winding forms a turn on an outer surface of the first magnetic plate. In one example of step 3602, windings 2920 are printed on first magnetic plate 2910 using a mask, such that each winding 2920 forms a respective winding turn 2922 on outer surface 2924, as illustrated in FIG. 37. In optional step 3604, one or more leakage control structures are disposed on respective portions of the outer surface of the magnetic plate, outside of winding turns. In one example of step 3604, leakage control structures 3307 are disposed on respective portions of outer surface 2924 outside of winding turns 2922, as illustrated in FIG. 38. In step 3606, a coupling magnetic structure formed of low permeability magnetic material is disposed on the outer surface of the magnetic plate, to provide a path for magnetic flux coupling the winding turns. In one example of step 3606, coupling magnetic structure 3318 formed of powder magnetic material within a binder, such as in the form of magnetic paste, is disposed on outer surface 2924, as shown in FIG. 39.

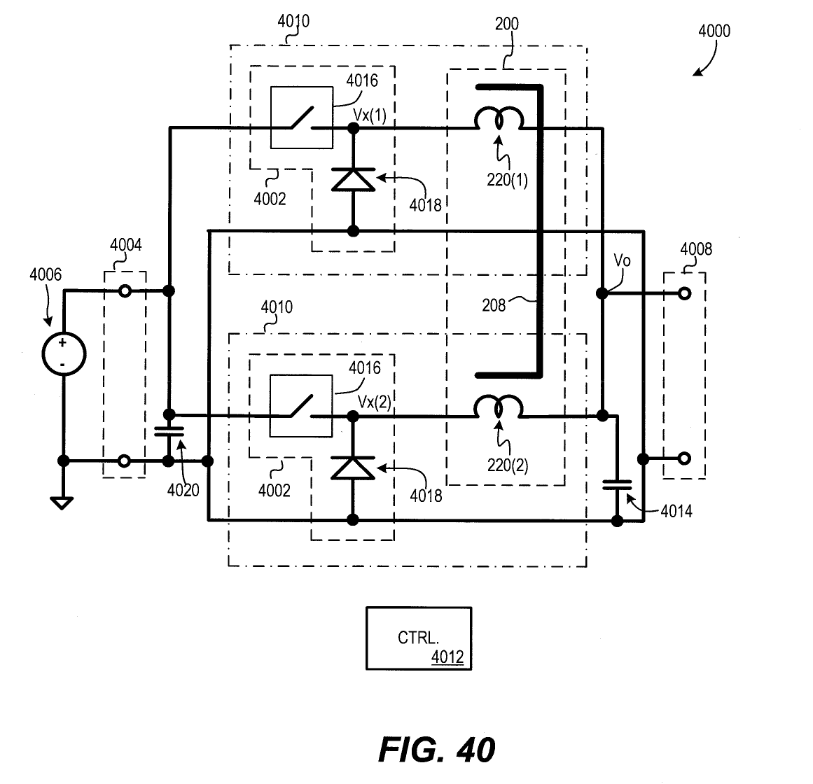

One possible application of the low-height coupled inductors disclosed herein is in multi-phase switching power converter applications, including but not limited to, multi-phase buck converter applications, multi-phase boost converter applications, or multi-phase buck-boost converter applications. For example, FIG. 40 illustrates one possible use of coupled inductor 200 (FIG. 2) in a multi-phase buck converter 4000. Each winding 220 is electrically coupled between a respective switching node Vₓ and a common output node Vₒ. A respective switching circuit 4002 is electrically coupled to each switching node Vₓ. Each switching circuit 4002 is electrically coupled to an input port 4004, which is in turn electrically coupled to an electric power source 4006. An output port 4008 is electrically coupled to output node Vₒ. Each switching circuit 4002 and respective inductor is collectively referred to as a “phase” 4010 of the converter. Thus, multi-phase buck converter 4000 is a two-phase converter.

A controller 4012 causes each switching circuit 4002 to repeatedly switch its respective winding end between electric power source 4006 and ground, thereby switching its winding end between two different voltage levels, to transfer power from electric power source 4006 to a load (not shown) electrically coupled across output port 4008. Controller 4012 typically causes switching circuits 4002 to switch at a relatively high frequency, such as at 100 kilohertz or greater, to promote low ripple current magnitude and fast transient response, as well as to ensure that switching induced noise is at a frequency above that perceivable by humans. Additionally, in certain embodiments, controller 4012 causes switching circuits 4002 to switch out-of-phase with respect to each other in the time domain to improve transient response and promote ripple current cancelation in output capacitors 4014.

Each switching circuit 4002 includes a control switching device 4016 that alternately switches between its conductive and non-conductive states under the command of controller 4012. Each switching circuit 4002 further includes a freewheeling device 4018 adapted to provide a path for current through its respective winding 220 when the control switching device 4016 of the switching circuit transitions from its conductive to non-conductive state. Freewheeling devices 4018 may be diodes, as shown, to promote system simplicity. However, in certain alternate embodiments, freewheeling devices 4018 may be supplemented by or replaced with a switching device operating under the command of controller 4012 to improve converter performance. For example, diodes in freewheeling devices 4018 may be supplemented by switching devices to reduce freewheeling device 4018 forward voltage drop. In the context of this disclosure, a switching device includes, but is not limited to, a bipolar junction transistor, a field effect transistor (e.g., a N-channel or P-channel metal oxide semiconductor field effect transistor, a junction field effect transistor, a metal semiconductor field effect transistor), an insulated gate bipolar junction transistor, a thyristor, or a silicon controlled rectifier.

Controller 4012 is optionally configured to control switching circuits 4002 to regulate one or more parameters of multi-phase buck converter 4000, such as input voltage, input current, input power, output voltage, output current, or output power. Buck converter 4000 typically includes one or more input capacitors 4020 electrically coupled across input port 4004 for providing a ripple component of switching circuit 4002 input current. Additionally, one or more output capacitors 4014 are generally electrically coupled across output port 4008 to shunt ripple current generated by switching circuits 4002.

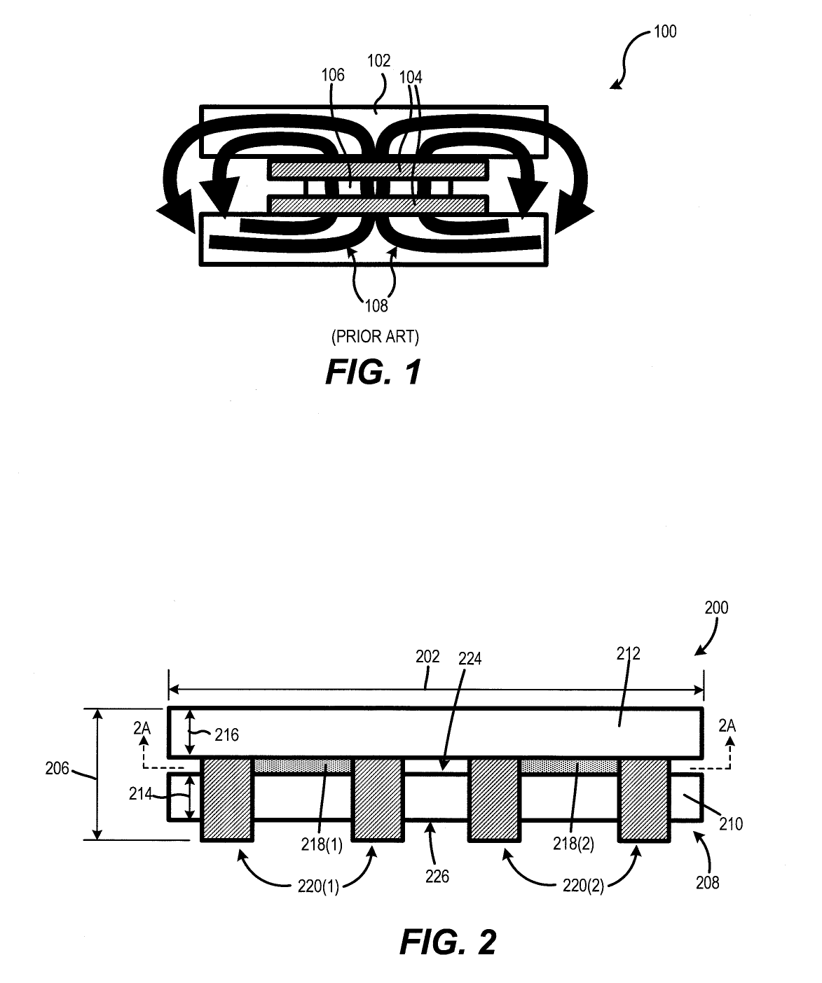

Buck converter 4000 could be modified to have a different number of phases. For example, converter 4000 could be modified to have three phases and use low-height coupled inductor 1100 of FIG. 1. Buck converter 4000 could also be modified to use one of the other low-height coupled inductors disclosed herein, such as low-height coupled inductor 1200, 1600, 1900, 2400, 2900, or 3300. Additionally, buck converter 4000 could also be modified to have a different multi-phase switching power converter topology, such as that of a multi-phase boost converter or a multi-phase buck-boost converter, or an isolated topology, such as a flyback or forward converter without departing from the scope hereof.

### Combinations of Features:

Features described above as well as those claimed below may be combined in various ways without departing from the scope hereof. The following examples illustrate some possible combinations:

(A1) A low-height coupled inductor having length, width, and height may include (1) a composite magnetic core, including: (i) first and second magnetic plates separated from each other in the height direction, and (ii) a plurality of coupling teeth connecting the first and second magnetic plates in the height direction, where the plurality of coupling teeth are formed of magnetic material having a lower magnetic permeability than magnetic material forming the first and second magnetic plates; and (2) a respective winding wound around each of the plurality of coupling teeth.

(A2) In the low-height coupled inductor denoted as (A1): the first and second magnetic plates may be formed of a ferrite magnetic material, and the plurality of coupling teeth may be formed of magnetic powder within a binder.

(A3) In either of the low-height coupled inductors denoted as (A1) or (A2), each of the first and second magnetic plates may have a rectangular shape.

(A4) In any of the low-height coupled inductors denoted as (A1) through (A3), each winding may be joined by a common tab, to form a winding assembly.

(A5) In any of the low-height coupled inductors denoted as (A1) through (A4), opposing ends of each winding may form a respective solder tab, and each solder tab may be disposed on an outer surface of the composite magnetic core.

(A6) In any of the low-height coupled inductors denoted as (A1) through (A4), opposing ends of each winding may form a respective solder tab, and each solder tab may extend away from the composite magnetic core in the widthwise direction.

(A7) In any of the low-height coupled inductors denoted as (A1) through (A6), each winding may form a respective turn on an outer surface of the first magnetic plate.

(A8) A multi-phase switching power converter may include (1) any one of the low-height coupled inductors denoted as (A1) through (A7) and (2) a respective switching circuit electrically coupled to each winding of the low-height coupled inductor, where each switching circuit is adapted to repeatedly switch an end of its respective winding between at least two different voltage levels.

(A9) The multi-phase switching power converter denoted as (A8) may further include a controller adapted to control each switching circuit such that the switching circuit switches out of phase with respect to each other switching circuit.

(B1) A low-height coupled inductor having length, width, and height may include: (1) a composite magnetic core including: (i) first and second magnetic plates separated from each other in the height direction, and (ii) first and second coupling teeth each connecting the first and second magnetic plates in the height direction, where the first and second magnetic plates and the first and second coupling teeth collectively form a passageway extending through the magnetic core in the widthwise direction, and where the first and second coupling teeth are formed of magnetic material having a lower magnetic permeability than magnetic material forming the first and second magnetic plates; and (2) first and second windings wound around the first magnetic plate and through the passageway.

(B2) In the low-height coupled inductor denoted as (B1), the first and second magnetic plates may be formed of a ferrite material, and the first and second coupling teeth may be formed of magnetic powder within a binder.

(B3) In either of the low-height coupled inductors denoted as (B1) or (B2), each of the first and second magnetic plates may have a rectangular shape.

(B4) In any of the low-height coupled inductors denoted as (B1) through (B3), each winding may be joined by a common tab, to form a winding assembly.

(B5) A multi-phase switching power converter may include (1) any one of the low-height coupled inductors denoted as (B1) through (B4) and (2) a respective switching circuit electrically coupled to each winding of the low-height coupled inductor, where each switching circuit is adapted to repeatedly switch an end of its respective winding between at least two different voltage levels.

(B6) The multi-phase switching power converter denoted as (B5) may further include a controller adapted to control each switching circuit such that the switching circuit switches out of phase with respect to each other switching circuit.

(C1) A low-height coupled inductor having length, width, and height may include: (1) a composite magnetic core including: (i) a magnetic plate, and (ii) a coupling magnetic structure disposed on an outer surface of the magnetic plate, where the coupling magnetic structure is formed of magnetic material having a lower magnetic permeability than magnetic material forming the magnetic plate; and (2) a plurality of windings, each of the plurality of windings forming a respective winding turn on the outer surface of the magnetic plate.

(C2) In the low-height coupled inductor denoted as (C1), the magnetic plate may be formed of a ferrite magnetic material, and the coupling magnetic structure may be formed of magnetic powder within a binder.

(C3) In either of the low-height coupled inductors denoted as (C1) or (C2), the magnetic plate may have a rectangular shape.

(C4) In any of the low-height coupled inductors denoted as (C1) through (C3), each winding turn may be formed around a respective center axis extending in the height direction, where center axis is offset from each other center axis in the lengthwise direction.

(C5) In any of the low-height coupled inductors denoted as (C1) through (C4), each winding turn may be non-overlapping with each other winding turn, as seen when the low-height coupled inductor is viewed cross-sectionally in the height direction.

(C6) Any of the low-height coupled inductors denoted as (C1) through (C5) may further include a plurality of leakage control structures formed of material having a lower magnetic permeability than the magnetic material forming the magnetic plate and the magnetic material forming the coupling magnetic structure, where each of the plurality of leakage control structures is disposed on a respective portion of the outer surface of the magnetic plate outside of the winding turns, as seen when the low-height coupled inductor is viewed cross-sectionally in the height direction.

(C7) In the low-height coupled inductor denoted as (C6), each of the plurality of leakage control structures may be disposed between the magnetic plate and the coupling magnetic structure, in the height direction.

(C8) In any of the low-height coupled inductors denoted as (C1) through (C7), each of the plurality of windings may be joined by a common tab, to form a winding assembly.

(C9) A multi-phase switching power converter may include (1) any one of the low-height coupled inductors denoted as (C1) through (C8) and (2) a respective switching circuit electrically coupled to each winding of the low-height coupled inductor, where each switching circuit is adapted to repeatedly switch an end of its respective winding between at least two different voltage levels.

(C10) The multi-phase switching power converter denoted as (C9) may further include a controller adapted to control each switching circuit such that the switching circuit switches out of phase with respect to each other switching circuit.

(D1) A method for forming a low-height inductor including a composite magnetic core may include the steps of: (1) disposing a plurality of windings on a first magnetic plate formed of a high permeability magnetic material, such that each of the plurality of windings forms a turn on an outer surface of the first magnetic plate; (2) disposing a low permeability magnetic material within each winding turn on the outer surface of the first magnetic plate, to form a plurality of coupling teeth; and (3) disposing a second magnetic plate formed of a high permeability magnetic material on the plurality of coupling teeth.

(D2) In the method denoted as (D1), the step of disposing low permeability magnetic material within each winding turn may include disposing a magnetic paste within each winding turn.

(D3) In either of the methods denoted as (D1) or (D2), each of the first and second magnetic plates may have a rectangular shape.

(D4) In any of the methods denoted as (D1) through (D3), each of the first and second magnetic plates may be formed of a ferrite magnetic material.

(D5) In any of the methods denoted as (D1) through (D4), the step of disposing the plurality of windings on the first magnetic plate may include disposing a winding assembly, including a common tab joining the plurality of windings, on the first magnetic plate.

(E1) A method for forming a low-height inductor including a composite magnetic core may include the steps of: (1) disposing a plurality of windings on a magnetic plate formed of a high permeability magnetic material, such that each of the plurality of windings forms a winding turn on an outer surface of the magnetic plate; and (2) disposing a coupling magnetic structure formed of a low permeability magnetic material on the outer surface of the magnetic plate.

(E2) The method denoted as (E1) may further include disposing leakage control structures on respective portions of the outer surface outside of the winding turns, before the step of disposing the coupling magnetic structure.

(E3) In either of the methods denoted as (E1) or (E2), the step of disposing the coupling magnetic structure may include disposing a magnetic paste on the outer surface of the magnetic plate.

(E4) In any of the methods denoted as (E1) through (E3), the magnetic plate may have a rectangular shape.

(E5) In any of the methods denoted as (E1) through (E4), the magnetic plate may be formed of a ferrite magnetic material.

(E6) In any of the methods denoted as (E1) through (E5), the step of disposing the plurality of windings on the magnetic plate may include disposing a winding assembly, including a common tab joining the plurality of windings, on the magnetic plate.

Changes may be made in the above methods and systems without departing from the scope hereof. It should thus be noted that the matter contained in the above description and shown in the accompanying drawings should be interpreted as illustrative and not in a limiting sense.

What is claimed is:

1. A low-height coupled inductor having length, width, and height, the low-height coupled inductor comprising:
a composite magnetic core, including:
first and second magnetic plates separated from each other in the height direction, and
a plurality of coupling teeth connecting the first and second magnetic plates in the height direction,
wherein the plurality of coupling teeth are formed of magnetic material having a lower magnetic permeability than magnetic material forming the first and second magnetic plates; and
a respective winding wound around each of the plurality of coupling teeth.

2. The low-height coupled inductor of claim 1, wherein:
the first and second magnetic plates are formed of a ferrite magnetic material; and
the plurality of coupling teeth are formed of magnetic powder within a binder.

3. The low-height coupled inductor of claim 2, wherein each of the first and second magnetic plates has a rectangular shape.

4. The low-height coupled inductor of claim 3, wherein each winding forms a respective turn on an outer surface of the first magnetic plate.

5. The low-height coupled inductor of claim 1, wherein each winding is joined by a common tab, to form a winding assembly.

6. The low-height coupled inductor of claim 1, wherein opposing ends of each winding form a respective solder tab, each solder tab being disposed on an outer surface of the composite magnetic core.

7. The low-height coupled inductor of claim 1, wherein opposing ends of each winding form a respective solder tab, each solder tab extending away from the composite magnetic core in the widthwise direction.

8. A low-height coupled inductor having length, width, and height, the low-height coupled inductor including:
a composite magnetic core, including:
first and second magnetic plates separated from each other in the height direction, and
first and second coupling teeth each connecting the first and second magnetic plates in the height direction,
wherein the first and second magnetic plates and the first and second coupling teeth collectively form a passageway extending through the magnetic core in the widthwise direction, and
wherein the first and second coupling teeth are formed of magnetic material having a lower magnetic permeability than magnetic material forming the first and second magnetic plates; and
first and second windings wound around the first magnetic plate and through the passageway.

9. The low-height coupled inductor of claim 8, wherein:
the first and second magnetic plates are formed of a ferrite material; and
the first and second coupling teeth are formed of magnetic powder within a binder.

10. The low-height coupled inductor of claim 8, wherein each winding is joined by a common tab, to form a winding assembly.

11. A low-height coupled inductor having length, width, and height, the low-height coupled inductor comprising:
a composite magnetic core, including:
a magnetic plate, and
a coupling magnetic structure disposed on an outer surface of the magnetic plate,
wherein the coupling magnetic structure is formed of magnetic material having a lower magnetic permeability than magnetic material forming the magnetic plate; and
a plurality of windings, each of the plurality of windings forming a respective winding turn on the outer surface of the magnetic plate.

12. The low-height coupled inductor of claim 11, wherein:
the magnetic plate is formed of a ferrite magnetic material; and
the coupling magnetic structure is formed of magnetic powder within a binder.

13. The low-height coupled inductor of claim 12, wherein the magnetic plate has a rectangular shape.

14. The low-height coupled inductor of claim 13, each winding turn being formed around a respective center axis extending in the height direction, each center axis being offset from each other center axis in the lengthwise direction.

15. The low-height coupled inductor of claim 13, each winding turn non-overlapping with each other winding turn, as seen when the low-height coupled inductor is viewed cross-sectionally in the height direction.

16. The low-height coupled inductor of claim 13, further comprising a plurality of leakage control structures formed of material having a lower magnetic permeability than the magnetic material forming the magnetic plate and the magnetic material forming the coupling magnetic structure, each of the plurality of leakage control structures disposed on a respective portion of the outer surface of the magnetic plate outside of the winding turns, as seen when the low-height coupled inductor is viewed cross-sectionally in the height direction.

17. The low-height coupled inductor of claim 16, each of the plurality of leakage control structures being disposed between the magnetic plate and the coupling magnetic structure, in the height direction.

18. The low-height coupled inductor of claim 11, wherein each of the plurality of windings is joined by a common tab, to form a winding assembly.

19. A method for forming a low-height inductor including a composite magnetic core, comprising the steps of:
disposing a plurality of windings on a first magnetic plate formed of a high permeability magnetic material, such that each of the plurality of windings forms a turn on an outer surface of the first magnetic plate;
disposing a low permeability magnetic material within each winding turn on the outer surface of the first magnetic plate, to form a plurality of coupling teeth; and
disposing a second magnetic plate formed of a high permeability magnetic material on the plurality of coupling teeth.

20. The method of claim 19, wherein the step of disposing low permeability magnetic material within each winding turn includes disposing a magnetic paste within each winding turn.

21. The method of claim 19, wherein the step of disposing the plurality of windings on the first magnetic plate includes disposing a winding assembly, including a common tab joining the plurality of windings, on the first magnetic plate.

22. A method for forming a low-height inductor including a composite magnetic core, comprising the steps of:
disposing a plurality of windings on a magnetic plate formed of a high permeability magnetic material, such that each of the plurality of windings forms a winding turn on an outer surface of the magnetic plate; and
disposing a coupling magnetic structure formed of a low permeability magnetic material on the outer surface of the magnetic plate.

23. The method of claim 22, further comprising disposing leakage control structures on respective portions of the outer surface outside of the winding turns, before the step of disposing the coupling magnetic structure.
